(19) United States
(12) Patent Application Publication
(10) Pub. No.: US 2007/0257506 A1
(43) Pub. Date: Nov. 8, 2007

(54) APPARATUS FOR FASTENING AN OBJECT

(76) Inventors: Kevin Brian Kenny, Cleveland, MO (US); Linda Lee Snyder, Simi Valley, CA (US)

Correspondence Address: SHELL OIL COMPANY, P O BOX 2463, HOUSTON, TX, 772522463, US

(21) Appl. No.: 11/743,398

(22) Filed: May 2, 2007

Related U.S. Application Data
(60) Provisional application No. 60/797,561, filed on May 4, 2006.

(51) Int. Cl. B62D 25/20

(52) U.S. Cl. 296/97.23

(57) ABSTRACT

An apparatus for securing an object to a penetrable material, said apparatus comprising: a. an external hollow cylinder; b. an internal cylinder, optionally including a safety housing, said internal cylinder, or internal cylinder and a safety housing, positioned within said external hollow cylinder, having essentially no permanent connection to the external hollow cylinder, rotatable within said external hollow cylinder, and having at least one means for piercing a penetrable material, said means positioned inside said internal cylinder or attached to the bottom surface thereof; and C. a means for mounting the apparatus.

### CROSS-REFERENCE TO RELATED APPLICATION

This application claims the benefit of U.S. Provisional Application No. 60/797,561, filed May 4, 2006, which is incorporated herein by reference.

### FIELD OF THE INVENTION

The present invention relates to an apparatus for securing an object to a material, such as textile or carpet, and more particularly relates to securing removable aftermarket carpet, or accessory mats, designed to overlie and protect the original factory carpet in automobiles, and other motor vehicles, and to the prevention of migration of removable aftermarket carpet.

### BACKGROUND OF THE INVENTION

Floor mats of the aftermarket, “throw-in”, or accessory, type are popularly used to protect the original carpet on the floor of automobiles from wear. Mats of this type are generally manufactured with a planar configuration and are often made of an elastomeric material sufficiently flexible to conform, when placed in use, to the multiplicity of shapes and contours characteristic of the floor of today's vehicles. Sometimes a carpet layer is secured to the top of the elastomeric material.

Most aftermarket carpet will migrate forward due to the lateral forces encountered in the daily use of the driver or passenger entering or exiting the car and in normal use while driving or riding in the car. This can result in the general disarray of the mat on the automobile floor. This tendency to shift or migrate defeats the purpose of protecting the underlying carpet from extreme levels of wear due to tracking of dirt, salt laden snow, and a number of other undesirable debris that causes the original carpet to fail prematurely. More importantly, this carpet migration is a serious safety concern. Movement on the driver's side can present a significant safety hazard if the mat shifts to interfere with the accelerator, brake pedal, or other controls. This can lead to accidents and liability. Therefore, the migration of aftermarket carpet is a problem.

Various approaches to address migration and slippage have been proposed in the art. Some aftermarket carpets are designed with some form of carpet gripping technology. One form of carpet gripping technology is nibs. Nibs protrude from the underside of the aftermarket carpet. These nibs are intended to mesh into the factory installed carpet. U.S. Pat. No. 3,559,231 and U.S. Pat. No. 4,198,734 utilize this approach. As an aggregate the nibs perform the function of antislipping. This improves the friction, but does not solve the problem of migration.

U.S. Pat. No. 4,033,011 discloses a car carpeting clip system including a plurality of lugs located on the metal car body and a similar plurality of hooked members attached to the backing of the carpeting. The carpeting is installed in the vehicle by placing the hooked members on the appropriate lugs.

U.S. Pat. No. 6,385,812 discloses a device for fastening an object to a textile layer comprising a body having a first face, a second face opposed the first face, and an axis defined to be at an angle to the first face and the second face, a plurality of elongate, resilient hook members extending axially outwardly from the first face, each hook member spaced from, and disposed in a helical path around the axis and terminating in a free end, the hook members adapted to engage the textile layer and a fastener affixed to the second face for fastening to the object. Also see U.S. Pat. No. 6,412,142.

U.S. Pat. No. 5,096,149 discloses a mounting device comprising a stem handle which has one or more protruding ridges encircling the stem and an elongated, corkscrew-shaped pointed pin axially extending from the center of one end of the stem handle.

Another example of methods to minimize aftermarket carpet migration is a mechanism resembling a hook that pushes into the carpet. This tool is usually placed toward the back of the mat area closest to the car seat. It generally protrudes out of the carpet about an inch. In order to utilize this mechanism the aftermarket carpet is designed with a hole in it located in the same position as that of the peg. The carpet is mounted over the peg in order to minimize the migration of the carpet forward. This is very similar to the factory style installations that are supplied in many of the new car models. In U.S. Pat. No. 6,381,806 there is disclosed a two piece retainer assembly used in conjunction with a hook-like fastener permanently mounted to the vehicle's floor surface.

There is a need in the art for a device to very effectively secure an aftermarket carpet in place so that it will not migrate. It would also be desirable if there were a method to permit quick release of the aftermarket carpet from the factory installed carpet. It would also be desirable if such a device could function to fasten a variety of accessories to any layer of textile or carpet.

### SUMMARY OF THE INVENTION

The present invention provides an apparatus for securing an object to a penetrable material, said apparatus comprising:

a. an external hollow cylinder;

b. an internal cylinder, optionally including a safety housing, said internal cylinder, or internal cylinder and a safety housing, positioned within said external hollow cylinder, having essentially no permanent connection to the external hollow cylinder, rotatable within said external hollow cylinder, and having at least one means for piercing a penetrable material, said means positioned inside said internal cylinder or attached to the bottom surface thereof; and

c. a means for mounting the apparatus.

In an embodiment of the invention the internal cylinder is inside a safety housing, both positioned within the external hollow cylinder, but having essentially no permanent connection to the external hollow cylinder, and both being free to rotate within the external hollow cylinder.

Though not preferred, it is also within the concept of the invention for the internal cylinder to be solid, with the means for piercing a penetrable material, selected from, for example, hooks, prongs, wires, and the like, attached to the bottom of the solid cylinder, without the use of a safety housing.

The present invention also provides a method of affixing an object to a penetrable material comprising:

a. positioning a first surface of an apparatus adjacent to an upper surface of the penetrable material, said apparatus comprising an external hollow cylinder and an internal cylinder having essentially no permanent connection to the external hollow cylinder, said internal cylinder having at least one means for piercing penetrable material positioned inside thereof, and said internal cylinder having holes in the surface adjacent the upper surface of the penetrable material, through which said means for piercing can protrude, said protruding being controlled by pressing and turning the surface of the internal cylinder opposite that surface positioned adjacent the upper surface of the penetrable material;

b. pressing the apparatus toward the first surface of the penetrable material while turning the internal cylinder of the apparatus, said pressing and turning providing for the protruding of the at least one means for piercing, and piercing the penetrable material with the at least one means for piercing at a respective plurality of spaced-apart locations; and

c. further rotating the apparatus to secure the apparatus to the penetrable material.

### BRIEF DESCRIPTION OF THE DRAWINGS

FIG. 1 is an exploded diagram of the parts of one embodiment of the pre-assembled apparatus, as the parts would appear from bottom to top.

FIG. 2 is a bottom view of one embodiment of the fastening apparatus showing the internal cylinder and lower rim of the safety housing inside the external hollow cylinder, and a mounting plate.

FIG. 3 shows an enlargement of one design of the safety housing and internal guiding system.

FIG. 4 is a top view of the assembled apparatus of FIG. 1.

FIG. 5 is a cross section of an alternative embodiment with no safety housing.

FIG. 6 shows another feature within the concept of the invention where there is a receptacle or recessed area in the top of the internal cylinder for receiving a tool for turning the internal cylinder.

FIG. 7A is a top view of the apparatus in an aftermarket carpet.

FIG. 7B is a view of the apparatus from the underneath side of an aftermarket carpet.

FIG. 8 shows the apparatus installed, and demonstrates the detachable, quick release feature.

### DETAILED DESCRIPTION OF THE INVENTION

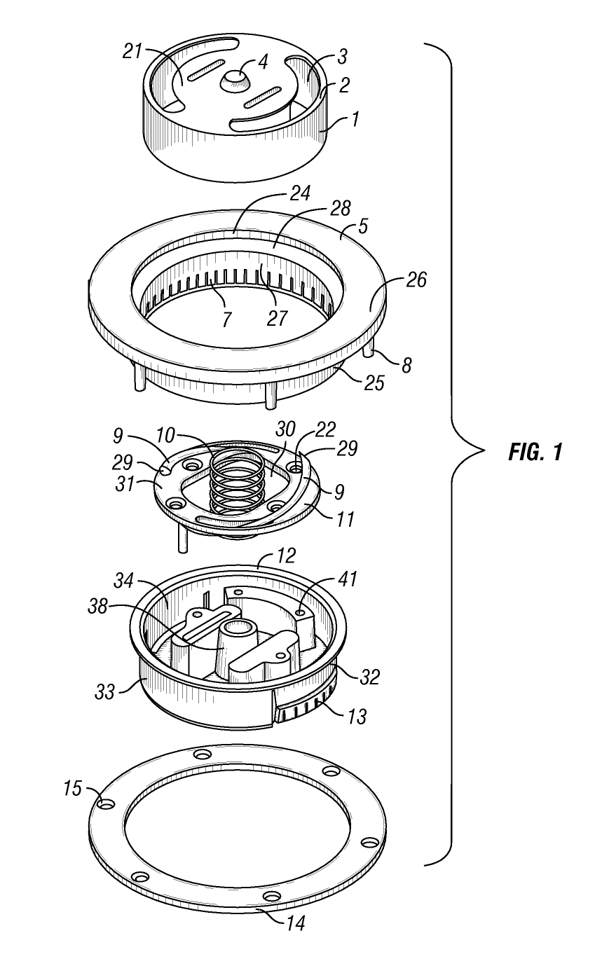

It should be noted that FIGS. 1, 2, and 3 depict bottom views of the devices, with the result that the top of the device, as it is intended to be used, lies toward the bottom of the page.

Referring initially to FIG. 1, one embodiment of the present apparatus includes an internal cylinder 1, an external hollow cylinder 5, a circular disc 11, a safety housing 12, and a mounting plate 14.

Internal cylinder 1 includes a side wall 2 and a bottom face 21. Bottom face 21 preferably includes at least one arcuate opening 3 and an outwardly extending boss 4, which may be centered on face 21. In some embodiments, the inside surface of bottom face 21 may include a means for retaining internal cylinder 1 on the apparatus.

External hollow cylinder 5 includes a body 25 having a radially extending flange 26 at its lower end. The inside diameter of body 25 is defined by inside surface 27, and is preferably only slightly larger than the outside diameter of safety housing 12, as described in detail below. The upper end of inside surface 27 of body 25 preferably includes a plurality of surface modifications 7, which may take the form of teeth, ridges, grooves, or the like. The lower end of inside surface 27 preferably includes a shoulder 28 and an enlarged diameter portion 24.

In some embodiments, the top surface (not shown in FIG. 1) of flange 26 preferably includes at least one peg 8 extending upwardly therefrom.

Circular disc 11 is preferably substantially flat and has a lower face 31 that supports at least one, and more preferably two, prongs 9. Each prong 9 preferably comprises an arcuate member having a sharpened distal end 29. Prongs 9 are mounted on disc 11 such that they extend away from lower face 31 and their distal ends are spaced apart from lower face 31. Circular disc 11 includes a central opening 30 therethrough. The diameter of circular disc 11 is preferably small enough to fit within the inside diameter of side wall 2 of internal cylinder 1.

Referring still to FIG. 1 and also to FIG. 3, safety housing 12 is preferably a substantially cylindrical body 32 comprising a side wall 33, a floor 35 and an open lower face 34. The inside diameter of side wall 33 is preferably slightly larger than the outside diameter of side wall 2 of internal cylinder 1. The lower end of side wall 33 preferably includes an outwardly extending lip 40, which approximately corresponds in size to shoulder 28 on external hollow cylinder 5.

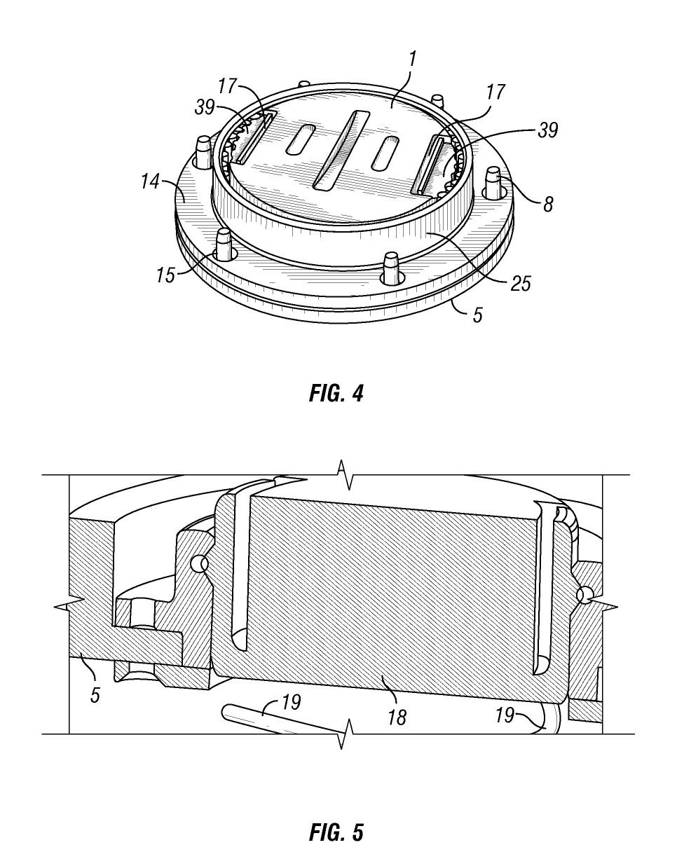

Within side wall 33, a plurality of supports 36 and a center mount 38 extend from floor 35. Supports 36 and center mount 38 are preferably shorter, or at least no taller than side wall 33. Supports 36 may comprise at least one receptacle 41 for receiving a means for attaching disk 11, for example, a screw. The means for attaching may pass through at least one hole 22 of disk 11. Supports 36 may include a means for retaining internal cylinder 1, as mentioned above. For example, a lip may be provided along a portion of the bottom edge of supports 36 nearest center mount 38 to engage a corresponding member located at the inner side of bottom face 21 of internal cylinder 1 so as to allow internal cylinder 1 to snap into place. Side wall 33 preferably includes four cuts or notches 37, which extend from the floor toward but not to the lower edge of side wall 33. Cuts 37 are preferably positioned in pairs, so that each pair of cuts defines a tab 39 therebetween. In addition, each tab 39 is preferably separated from floor 35 by a gap 17 (FIGS. 3 and 4), which allows tabs 39 to be deformed slightly relative to body 32, as described in detail below. In some embodiments, prongs 9 may be mounted on supports 36. Disk 11 may be used to add protection and to secure the prongs in place.

Mounting plate 14 preferably comprises a substantially planar ring, having an inside diameter slightly larger than the outside diameter of external cylinder body 25 and an outside diameter that may be selected to provide a desired width. In some embodiments, at least one, and preferably a plurality of holes 15 extend through the thickness of plate 14. In other embodiments, holes 15 may be omitted, or replaced with depressions or receptacles.

In preferred embodiments, a coil spring 10, which may comprise a coiled wire, is provided for use between circular disc 11 and internal cylinder 1, as described below. In some embodiments, the upper end of spring 10 may be affixed to the floor 35 of safety housing 12.

When it is desired to assemble the apparatus, spring 10 is positioned around center mount 38 of the safety housing 12 and circular disc 11 is positioned so that it rests on supports 36. Internal cylinder 1 is advanced over spring 10 and disc 11. In this manner, internal cylinder 1 is attached to, for example, snapped into, safety housing 12, but is supported in an extended position by spring 10. In some embodiments, the lower end of spring 10 may be affixed to the inner surface of internal cylinder 1. Also for example, at least one means for attaching, for example, at least one screw, may be passed through at least one hole 22 of disk 11 and engaged with at least one receptacle 41 of supports 36. In the extended position, internal cylinder 1 encloses prongs 9, thereby preventing unintentional engagement of prongs 9 with other objects. At the same time, because spring 10 is compressible, internal cylinder 1 can be advanced toward safety housing 12, thereby exposing increasing amounts of prongs 9.

When connected in this manner, internal cylinder 1, disc 11 and safety housing 12 form one component of the present device, which will hereinafter be referred to as the “carpet engaging component”. External cylinder 5 forms a second component of the present device. The carpet engaging component can be snapped into releasable, rotatable engagement with external cylinder 5 by elastically deforming tabs 39 so that they snap over and engage surface modifications 7. The carpet engaging component is prevented from passing all the way through external cylinder 5 by the engagement of lip 40 with shoulder 28. In this manner, the carpet engaging component is retained within the external cylinder.

The carpet engaging component can be rotated relative to the external cylinder by applying sufficient rotational force to overcome the engagement of tabs 39 from surface modifications 7, or by depressing tabs 39 radially inwardly, so that they disengage from surface modifications 7.

The carpet engaging component can be released from the external cylinder by depressing tabs 39 radially inwardly, so that they disengage from surface modifications 7, allowing the carpet engaging component to be removed from the lower end of the external cylinder.

The device of the present system is installed in a carpet or other object that is desired to be secured, by creating a hole in the carpet that is large enough to receive external cylinder 5. With or without the carpet engaging component present in the external cylinder, the external cylinder is attached to the lower surface of the carpet by pressing pegs 8 into the carpet fiber. In preferred embodiments, mounting plate 14 is applied to the opposite surface of carpet and pegs 8 pierce the carpet and engage holes 15 therein. It will be understood that mounting plate 14 could be omitted and that external cylinder 5 and/or mounting plate 14 could each be affixed to the carpet by any suitable means, including adhesive.

Once external cylinder 5 is affixed to the carpet, the carpet engaging component can be placed into engagement with external cylinder 5, if it is not already in place.

To use the device, the carpet, floormat, or other object to be attached, including the external cylinder, optional mounting plate, and the carpet engaging component is placed on the upper surface of a second carpet. By pressing the device downward, the fibers of the second carpet bear on the lower surface of internal cylinder 1, thereby compressing spring 10 and at least partially exposing the tips 29 of prongs 9. By then rotating safety housing 12 relative to external cylinder 5, which is attached to the first carpet, prongs 9 can be advanced into deeper engagement with the fiber of the second carpet, thereby securing the device. This engagement of prongs 9 with the second carpet can be carried out regardless of whether the carpet engaging component is attached to the external cylinder. Once the carpet engaging component is secured in this manner and is attached to the external cylinder, the first carpet is held in the desired position on the second carpet.

To release the first carpet, tabs 39 are depressed inwardly, allowing external cylinder 5 to slip off of the carpet engaging component. The carpet engaging component can then be removed from the second carpet by rotating it in the reverse direction so as to disengage prongs 9.

The present invention relates to a manually operated locking device for attaching an object to a layer of carpet or material. The invention is useful for fastening or securing an object to a material such as, for example, textile, factory installed automobile carpet, or any penetrable material. The use of the invention to fasten aftermarket or accessory carpet to factory installed carpet in an automobile is exemplified herein.

In a first embodiment the invention comprises a manually operated locking apparatus for fastening or securing an object to a material such as, for example, textile, factory installed automobile carpet, and the like comprising:

a. an external hollow cylinder;

b. an internal cylinder inside a safety housing, both positioned within the external hollow cylinder, but having essentially no permanent connection to the external hollow cylinder;

c. said safety housing containing a spring, said spring positioned inside the safety housing, such that said spring is extended when the apparatus is not in use and retracted when the internal cylinder is pressed and turned;

d. said safety housing also containing a disk with at least one means for piercing a penetrable material attached, selected from, for example, prongs, hooks, and the like, and a guiding system which guides the prongs or hooks to protrude and penetrate textile or carpet when the internal cylinder is turned and the spring retracted; and

e. a means for mounting the apparatus to the object to be fastened.

As mentioned, in the first embodiment the safety housing contains a spring. The spring functions as a safety feature to keep the prongs from protruding when the apparatus is not in use. The depression of the spring is controlled by, for example, pressing and turning the internal cylinder. The safety housing also contains a disk having one or more prong(s) and/or hook(s) attached thereto. When the internal cylinder is pressed and turned and the spring depressed, the prong(s) and/or hook(s) are guided out of the apparatus to penetrate a layer of textile or carpet.

Also within the scope of the invention is a second embodiment with no safety housing comprising an external hollow cylinder, a solid internal cylinder having prong(s), hook(s), or wire(s) attached to the bottom thereof and having essentially no permanent connection to the external hollow cylinder, and a mounting plate.

An additional aspect of embodiments of the invention is surface modifications, such as ridges, grooves, or serrations, on the outside circumference of the internal cylinder or safety housing, and ridges, grooves, or serrations on the inside circumference of the external hollow cylinder, which provide a means of locking the apparatus in place. In one embodiment the surface modifications on the inside circumference of the external hollow cylinder may be placed around the entire circumference, while the surface modifications on the outside circumference of the internal cylinder or safety housing may be positioned on designated portions of the circumference. This makes it possible for the internal cylinder to lock in place with the external hollow cylinder after being, for example, pressed and turned to install the aftermarket carpet. In a preferred embodiment the surface modifications on the internal cylinder comprise one or more flexible tabs with ridges on the external circumference of the safety housing of the internal cylinder. These tabs have a small space behind each tab and can be pinched or pressed to reduce the diameter of the internal cylinder. This design provides for a quick release or detachable feature to separate the external hollow carpet ring or cylinder, which is attached to the aftermarket carpet, or floormat, and the internal cylinder that remains attached to the factory installed carpet.

It is also within the scope of the invention for the top of the internal cylinder to include an indentation, slot, receptacle, or recessed area for receiving a tool to turn the internal cylinder and cause the prong(s) or hook(s) to penetrate the base membrane fibers of the factory carpet. In the embodiment exemplified in FIG. 4 herein the top surface of the internal cylinder includes a slot for the convenient use of a coin to turn the internal cylinder.

The fastening apparatus of the invention is useful for many applications. One example of the use of the fastening apparatus is as a carpet grabber to manually attach and lock in place aftermarket carpet, for example a floormat, to the factory installed (Original Equipment Manufacturer, hereafter referred to as OEM) carpet in an automobile. The fastening apparatus of the first embodiment is employed by simply pressing and turning the internal cylinder, optionally with a coin, causing the spring in the safety housing to retract and the prong(s) or hook(s) to rotate and protrude into the underlying layer of OEM carpet, penetrating the OEM carpet and thus securing the aftermarket carpet in place. As discussed above, the surface modifications on the outside of the internal cylinder and inside of the external cylinder make it possible for the apparatus to lock in place after the consumer has turned the internal cylinder for installation. After the apparatus is locked in place, it is semi-permanent and very effectively prevents migration of the aftermarket carpet. Another advantage, as mentioned above, is that the apparatus can be quickly released.

One or more embodiments of the present invention are further described in detail by way of example only with reference to the accompanying drawings. FIG. 1 shows a diagram of the parts of the preassembled fastening apparatus as they would appear from bottom to top, with internal cylinder 1 having openings 3, where the prong(s) or hooks(s) emerge, as the part of the apparatus which is pushed and turned into the original factory installed carpet. In FIG. 1, the mounting plate 14, having one or more holes 15 spaced around the perimeter, would function to help anchor the apparatus to the object, for example, the accessory carpet mat to be secured. 1 represents the internal hollow cylinder which, in the first embodiment, when assembled, is inside the safety housing 12. The safety housing 12 is positioned inside the external hollow cylinder 5 but is essentially not permanently attached to it in any way. Inside the safety housing 12 there is also a spring wire 10 that is positioned in such a way that it is retracted by turning the internal cylinder 1. Also within the safety housing 12 is a circular disk 11 that incorporates at least one means 9 for, or tool for, piercing a penetrable material, selected from, for example, prong(s), hook(s), wire(s) and the like, attached thereto. In FIG. 1, 9 represents one of two prong(s), approximately equally spaced on disk 11. This is only for the purpose of illustration, as there could be different numbers and sizes of prong(s) or hook(s) and different spacing of prong(s) or hook(s) depending upon the application. The prong(s) 9 is attached at an angle, which along with the guiding system (See FIG. 3), causes prong(s) 9 to enter the original carpet at an angle, thus permitting the prong(s) to engage the original carpet without damaging the floorboard. Safety housing 12 utilizes spring wire 10 to extend out and protect the user from the prong(s) 9 when prong(s) 9 are not in use. The prong(s) or hook(s) may be attached to safety housing 12, or to circular disk 11 in safety housing 12, as shown in FIG. 1, for example, using screws, adhesives, soldering, or other means for securing.

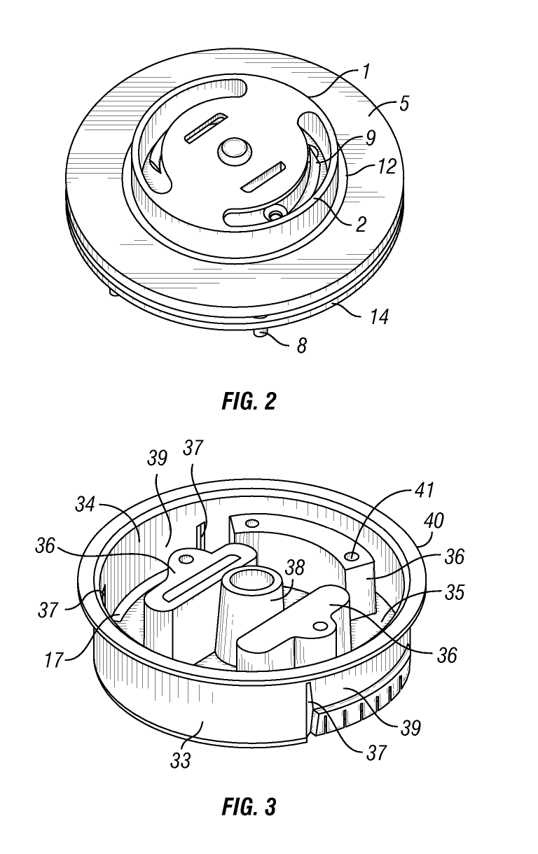

The internal cylinder 1 is pressed and turned from the top, which view is shown in FIG. 4. When the internal cylinder 1 is pressed and turned and the spring wire 10 (FIG. 1) compressed, the prong(s) 9 (FIGS. 1 and 2) are turned and guided out of the apparatus through an internal guiding system (see FIG. 3) in the safety housing to penetrate the factory carpet or other layer to be attached.

Again referring to FIG. 1, the bottom surface of internal cylinder 1 includes openings 3 where the prong(s) protrude when the internal cylinder is pressed. Around the outside circumference of the safety housing 12 are surface modifications 13 shaped to provide part of a gear assembly, wherein the surface modifications 13 on the outside of the circumference include, for example, ridges, grooves, serrations or any design that will permit the surface to engage with another surface, that is the inside surface of the circumference of the external hollow cylinder 5. The inside circumference of the external hollow cylinder 5 also includes surface modifications 7, such as, for example, ridges, grooves, and serrations. In FIG. 1, the surface modifications 7 inside the external hollow cylinder 5 are situated around the entire inside circumference. The corresponding surface modifications 13 on the outside of safety housing 12 of internal cylinder 1 are on the edges of one or more tabs on the external circumference of safety housing 12 and need not extend around the entire circumference. (See also, for example, flexible tabs 39 of FIG. 4.)

Again referring to FIG. 1, the external hollow cylinder 5 also has one or more protrusions or pegs 8 protruding from, and generally evenly spaced around, the periphery of the circumference. These protrusions or pegs 8 assist in positioning the apparatus on the mounting plate 14 and in securing the object to be attached. When the apparatus is assembled and in use, the surface modifications 7 on external hollow cylinder 5 are engagable in gear fashion with the safety housing ridges or grooves 13. The safety housing 12 may be turned with the internal cylinder 1. The contact of ridges 7 and grooves 13, comprises a gear design and prevents internal cylinder 1 from reversing after installation in the factory carpet, and it incorporates a type of braking technology into the design. Without this design, under normal driving conditions, internal cylinder 1 could possibly vibrate itself in a counterclockwise motion and disconnect prong(s) 9 or hook(s) from the factory carpet.

Again referring to FIG. 1, the internal cylinder 1 positioned in the safety housing 12, with the spring wire 10, and prong(s) 9 situated within, moves upward and downward inside the external hollow cylinder 5, similar to a piston in the cylinder of an automobile engine. The difference here is that the internal cylinder 1 and safety housing 12 rotate clockwise half of a turn to drive the piston downward the full length of the range and half rotation counter clockwise to drive the inner piston the full length upwards. Where the internal cylinder 1 is positioned within the safety housing 12, the two parts operate as one. The internal cylinder 1 may fit inside the safety housing 12 such that internal cylinder 1 and safety housing 12 move as one piece and may, for example, be fastened together, for example, using screws, adhesive, or other means for securing. Though not preferred, if the use of the safety housing were omitted, for example, the internal cylinder 1 could move upward and downward within the external hollow cylinder 5.

FIG. 2 is a larger view of the bottom surface of the apparatus showing the internal cylinder 1 and rim of the safety housing 12 inside the external hollow cylinder 5 on a mounting plate 14. FIG. 2 also shows in greater detail the position of the prong(s) 9 prior to protrusion for installation. FIG. 2 also shows side wall 2 and at least one peg 8.

FIG. 3 is a view showing an enlargement of one design of the safety housing and internal guiding system. Those skilled in the art will see other possible designs. (See also, for example, safety housing 12 of FIG. 1.)

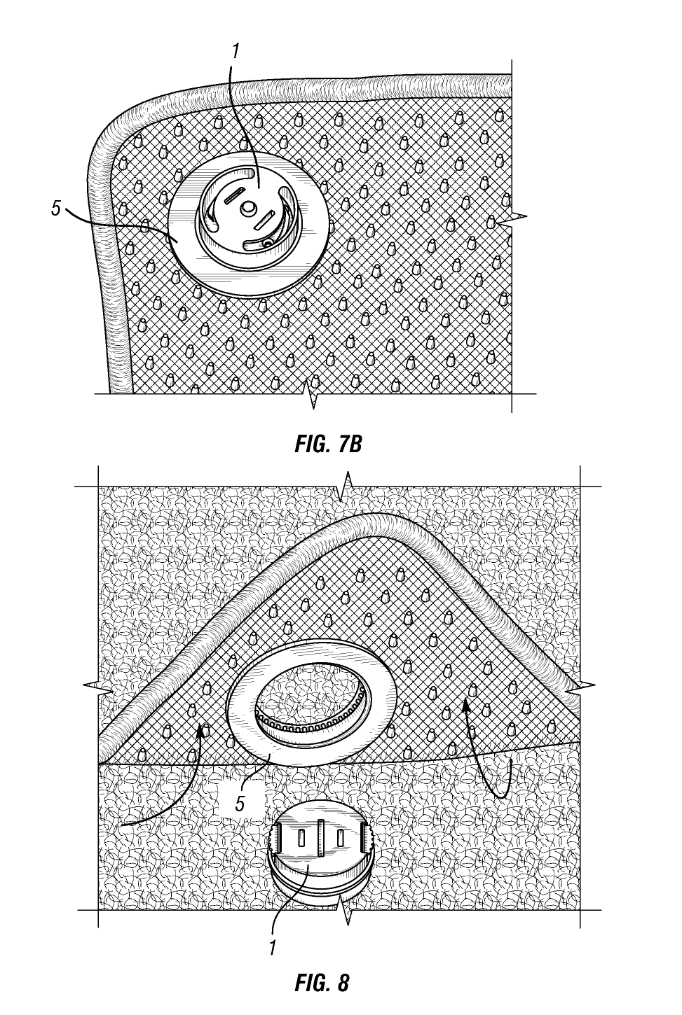

In one embodiment the means for mounting the apparatus include, for example, the use of one or more of the mounting plate 14, external hollow cylinder 5, pegs 8, and holes 15. Referring now to FIG. 4, the aftermarket carpet (not shown) may be attached to the apparatus by the aftermarket carpet being positioned between mounting plate 14 and external hollow cylinder 5 and intermeshed among protrusions or pegs 8. It is also within the scope of the invention for the aftermarket carpet to be mounted between the mounting plate 14 and external hollow cylinder 5 and intermeshed among protrusions or pegs 8, where the holes 15 may not be present or not functioning, for example, may be plugged with, for example, material utilized in the manufacture of the apparatus. For example, protrusions or pegs 8 may be connected to both mounting plate 14 and external hollow cylinder 5 with the aftermarket carpet in between mounting plate 14 and external hollow cylinder 5, intermeshed among pegs 8 and against external hollow cylinder 5, for example, against body 25 of external hollow cylinder 5. Also for example, mounting plate 14 may be semi-permanently or permanently affixed to external hollow cylinder 5, for example, affixed to body 25 of external hollow cylinder 5, by any suitable means, including ultrasonic welding, hot plate welding, Rf or high frequency welding, or grommet die press, with, for example, the aftermarket carpet in between mounting plate 14 and external hollow cylinder 5, intermeshed among pegs 8 and against external hollow cylinder 5, for example, against body 25 of external hollow cylinder 5. Also for example, mounting plate 14 may be in the form of a snap-on ring that may be snapped into releasable engagement with, or semi-permanently affixed to, pegs 8. The apparatus may be assembled in an aftermarket carpet with a hole prepared for the apparatus as an integral part of an aftermarket carpet. This will be shown, for example, in FIGS. 7A and 7B.

FIG. 4 shows a view of the top of the apparatus with the top of the internal cylinder 1 positioned inside the external hollow cylinder 5. The flexible tabs 39, having a small space 17 behind each tab, can be pressed inward to allow the external hollow cylinder 5 and mounting plate 14, with aftermarket carpet (not shown) attached, to detach from the internal cylinder 1 which remains attached to the factory carpet (not shown). This detachable design allows for a quick release to separate the external hollow cylinder 5 and mounting plate 14 from the internal cylinder 1. The advantage here is that when the consumer attaches the apparatus to the factory carpet, the consumer can leave the internal cylinder 1 semi-permanently attached to the factory carpet and can easily remove the aftermarket carpet from this attachment, for example, for cleaning. This will be demonstrated further with reference to FIG. 8.

FIG. 5 is an alternative embodiment without the safety housing, wherein the internal cylinder 18 is solid. This design is not the preferred embodiment, but is within the concept of the invention. FIG. 5 shows a cross section of the external hollow cylinder 5 with an internal solid cylinder 18 positioned inside. The external cylinder 5 has essentially no permanent connection with the internal solid cylinder 18. The internal solid cylinder 18 moves upward and downward inside the external hollow cylinder 5 similar to a piston in the cylinder of an automobile engine. In this cross sectional view are two prongs 19, representing the piercing part of one prong 19 and the middle part of another prong 19, approximately equally spaced and embedded in, or attached to, the bottom of the internal solid cylinder 18. There can be any number of prong(s), hook(s), or wire(s), but two prongs are shown here for example. The prong(s) or hook(s) protrude from the bottom of the solid cylinder in a downward curve fashion. Each prong or hook is positioned at, for example, one-half interval on the bottom surface of the internal solid cylinder 18. For example, when the internal cylinder is pushed downward and rotated clockwise to drive the prong(s) or hook(s) beneath the base membrane of the factory-installed carpet, the prong(s) are guided into the factory-installed carpet. The apparatus as shown in FIG. 5 can lock in place if surface modifications are incorporated on the inside circumference of the external hollow cylinder 5 and the outside circumference of the internal solid cylinder 18.

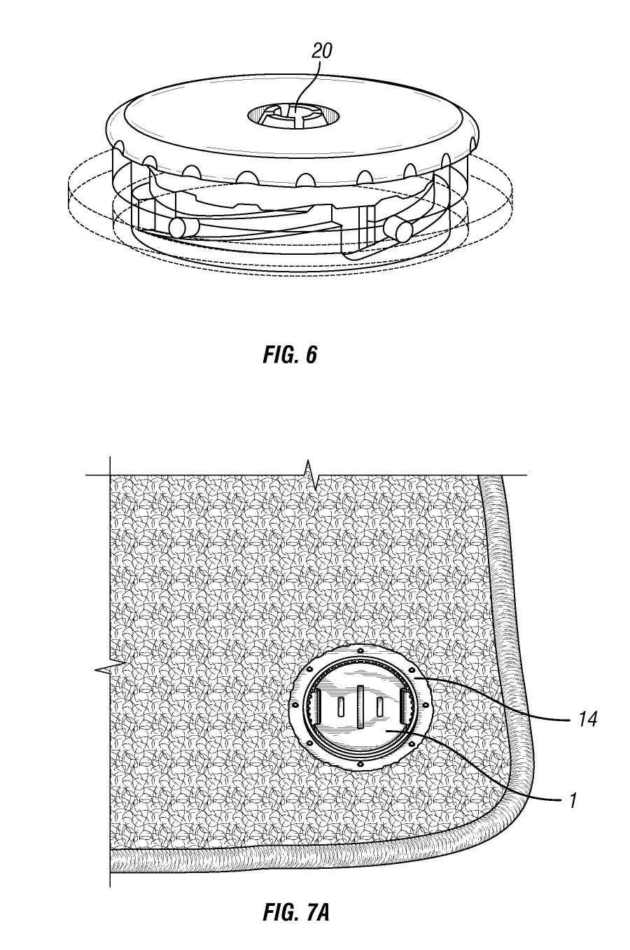

FIG. 6 shows another possible feature within the concept of the invention comprising a receptacle 20 for receiving a tool to turn the internal cylinder that will leverage the turning of the internal cylinder, and, for example, while applying pressure downward, drive the ends of the prong(s) or hook(s) down through the base membrane fibers of the factory automobile carpet thereby attaching the aftermarket floor mat to the factory installed carpet and locking the assembly into place.

FIG. 7A shows a top view of the apparatus, for example, comprising internal cylinder 1 and mounting plate 14, positioned close to the corner of an aftermarket carpet, and preferably installed close to the driver's seat or passenger's seat, as opposed to the vicinity of the gas or brake pedal.

FIG. 7B shows the apparatus, for example, comprising internal cylinder 1 and external hollow cylinder 5, from the underneath side of the aftermarket carpet.

FIG. 8 shows how the aftermarket carpet with the external hollow cylinder 5 attached can be detached from the internal cylinder 1 attached to the factory carpet, leaving the internal cylinder 1 securely in place so that the aftermarket carpet can be quickly reinstalled after being shaken out or cleaned.

Suitable compositions for an apparatus of the invention would preferably be malleable for manufacture and tough and durable in use. Examples of suitable materials include thermoplastic materials and rubber. Suitable thermoplastic materials may include, for example, polystyrene (PS), poly (vinylchloride) (PVC), acrylonitrile butadiene styrene (ABS), polyethylene (PE), polypropylene (PP), polycarbonate (PC), polyamide (PA—nylon), and polycarbonate acrylonitrile butadiene styrene (PC/ABS).

The prong(s), hook(s), or spring wire(s) of an apparatus of the invention may be made of a number of materials as will be apparent to those skilled in the art. Suitable compositions would not easily deform and should be resistant to attack by substances deposited in automobile carpet, such as, for example, water, grease, and salt. Metal meets these requirements, particularly steel, for example, high tensile strength stainless steel or high tensile strength stainless spring steel.

Those skilled in the art will see a number of other possible uses for the apparatus of the present invention. The apparatus would not only be useful for holding aftermarket carpet in place, but may also be useful, for example, to hold automotive litter bags to the upholstery on a car door or the back of a front passenger seat. The fastening apparatus may also be useful for trunk organizers. The apparatus may also be useful for mounting items on textile covered partitions in offices. The main inner body wall of these partitions is extremely difficult to penetrate. Using the apparatus of this invention the user simply pushes the item on the wall and the prong(s), hook(s), wire(s), or spring wire(s) penetrate the fabric but not the inner wall. Again, the quick release feature provides for quick removal. Other applications may be apparent to those skilled in the art.

The foregoing description is intended only as a means of illustration and should not be construed as limiting the scope of the invention in any way. Those skilled in the art will recognize many variations that may be made without departing from the spirit of the disclosed invention.

What is claimed is:

1. An apparatus for securing an object to a penetrable material, said apparatus comprising:
a. an external hollow cylinder;
b. an internal cylinder, optionally including a safety housing, said internal cylinder, or internal cylinder and a safety housing, positioned within said external hollow cylinder, having essentially no permanent connection to the external hollow cylinder, rotatable within said external hollow cylinder, and having at least one means for piercing a penetrable material, said means positioned inside said internal cylinder or attached to the bottom surface thereof; and
c. a means for mounting the apparatus.

2. The apparatus of claim 1 wherein the object to be secured is an automobile accessory that requires stabilization and wherein the penetrable material is selected from the group consisting of a textile layer, carpet, and factory installed automobile carpet.

3. The apparatus of claim 1 wherein the internal cylinder is in the safety housing and both internal cylinder and safety housing rotate as one unit within the external hollow cylinder.

4. The apparatus of claim 3 wherein the external hollow cylinder has surface modifications on the surface of the inside circumference and the safety housing has surface modifications on the surface of the outside circumference, said modifications on the external hollow cylinder and safety housing being engagable in a gear design.

5. The apparatus of claim 4 wherein the safety housing contains a disk having said at least one means for piercing a penetrable material attached thereto.

6. The apparatus of claim 5 wherein the safety housing contains a spring having a top end and a bottom end positioned within the safety housing such that said spring is extended when the apparatus is not in use and retracted when the internal cylinder is pressed.

7. The apparatus of claim 6 wherein when said internal cylinder is turned and said spring retracted, said at least one means for piercing protrudes out of the safety housing and wherein the safety housing contains a guiding system which guides the at least one means for piercing.

8. The apparatus of claim 7 wherein the gear design permits the external hollow cylinder and internal cylinder to lock in place.

9. The apparatus of claim 8 wherein one or more portions of the upper outer circumference of the top surface of the safety housing of the internal cylinder comprise surface modifications and comprise one or more spaces behind said surface modifications such that said designated portions of the circumference can be depressed to reduce the diameter of the internal cylinder and permit release from the external hollow cylinder.

10. The apparatus of claim 1 wherein the at least one means for piercing a penetrable material is selected from prongs, hooks, and wires.

11. The apparatus of claim 1 wherein the top of the internal cylinder comprises a recessed area.

12. The apparatus of claim 2 wherein the automobile accessory is an aftermarket or accessory automobile floor mat.

13. The apparatus of claim 2 wherein the automobile accessory is an automobile litter bag.

14. The apparatus of claim 2 wherein the automobile accessory is a trunk organizer.

15. The apparatus of claim 4 wherein the surface modifications are selected from ridges, grooves, and serrations.

16. A method of affixing an object to a penetrable material comprising:
a. positioning a first surface of an apparatus adjacent to an upper surface of the penetrable material, said apparatus comprising an external hollow cylinder and an internal cylinder having essentially no permanent connection to the external hollow cylinder, said internal cylinder having at least one means for piercing penetrable material positioned inside thereof, and said internal cylinder having holes in the surface adjacent the upper surface of the penetrable material, through which said means for piercing can protrude, said protruding being controlled by pressing and turning the surface of the internal cylinder opposite that surface positioned adjacent the upper surface of the penetrable material;
b. pressing the apparatus toward the first surface of the penetrable material while turning the internal cylinder of the apparatus, said pressing and turning providing for the protruding of the at least one means for piercing, and piercing the penetrable material with the at least one means for piercing at a respective plurality of spaced-apart locations; and
c. further rotating the apparatus to secure the apparatus to the penetrable material.
